(19) United States
(12) Patent Application Publication
(10) Pub. No.: US 2009/0146432 A1
(43) Pub. Date: Jun. 11, 2009

(54) VERTICAL AXIS WIND TURBINE

(76) Inventor: Abraham E. Ballena, Binangonan (PH)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/887,852

(22) PCT Filed: Sep. 2, 2005
(86) PCT No.: PCT/PH2005/000019

§ 371 Date: Oct. 4, 2007

(51) Int. Cl. F03D 9/00; F03D 3/02; F03D 7/06

(52) U.S. Cl. 290/55; 416/120; 416/32

(57) ABSTRACT

A vertical axis wind turbine (10) comprises two turbine rotors (12) and (13) with a plurality of curved blades (14) and (15) and coupled together by gears underneath their shafts and rotating synchronously in opposite directions, a multi-function center enhance (16) with three sections namely, the front deflector (21), the upwind blade cavity (22) and the turbulence reducer (23) and together with the two side deflectors (17) and (18) contribute to the efficient flow of the wind stream to the downwind moving blades (28) and (29) of the two turbine rotors. The center enhance separates the two turbine rotors on opposite sides. The wind turbine (10) has a cylindrical housing structure (11) with two levels of horizontal platform (19) and (20) housing various components of the machine, and a yaw drive mechanism that orients properly the machine into the wind.

### FIELD OF THE PRESENT INVENTION

The present invention relates to a vertical axis wind turbine that converts wind energy into mechanical or electrical energy. It includes two vertical axis wind turbine rotors with a plurality of curved blades, a multi-function center enhancer and two side deflectors. It is house in a cylindrical structure, which is being orient properly into the wind by a yaw drive mechanism and rotates on a turntable bearing assembly.

### BACKGROUND OF THE PRESENT INVENTION

There are two major types of wind machines, or windmills or wind turbines base on their method of rotor propulsion. The first one is the drag-type rotor on which the direct impact of the wind against the blade provides motive force. This machine depends on a difference in drag between the power-producing blade moving downwind and the opposite blade, moving upwind. The curved shape of the blade permits this difference in drag forces. The second one is the lift-type rotor, which use aerodynamic lifting forces caused by airflow over blades shaped like airfoils to turn the rotor.

Wind machines are also classified according to the orientation of the axis of rotation of the rotor relative to the wind stream. These include the horizontal axis wind machines on which the axis of rotation of the rotor is parallel to the direction of the wind stream, and the vertical axis wind machines on which the axis of rotation of the rotor is perpendicular to both the surface of the earth and the wind stream.

The present invention is a vertical axis wind turbine of the drag-type rotor. Prior arts of this invention come in different designs, shapes and configurations of the rotors such as flat, curved, conical and helical. These prior arts are known to be of low efficiency.

Other prior arts come with stationary wind deflectors or wind-directing blades of various shapes, configurations and dispositions around the rotor to increase efficiency. One disadvantage of these prior arts is wherever the headwind blows each stationary blades present themselves in different angle and position and therefore of different factor in efficiency and usefulness.

Other prior arts come with two rotors with wind-deflecting shield in front covering the upwind moving blades of the two rotors. Most wind-deflecting shields of these prior arts have limited function and are not of ideal shape, and produces significant drag and turbulence to affect efficiency. Some have unstable base that require cables to support the structure making it impracticable to install on a constricted places such as on a sailing vessel or on top of the roof of a narrow building.

The present invention is an improvement on these prior arts.

### SUMMARY OF THE PRESENT INVENTION

The present invention discloses a vertical axis wind turbine with two turbine rotors with a plurality of curved blades and coupled together by gears and rotating synchronously in opposite directions. This machine includes a unique multi-function center enhancer, which as symmetrical shape on both sides and is positioned at the center of the upper level platform of the housing structure and separates the two turbine rotors on opposite sides. Abreast of the two turbine rotors on opposite sides of the center enhancer and flushed with the cylindrical housing structure side are the two side deflectors.

The center enhancer eliminates the headwind to the upwind moving blades of the two rotors and redirects it to the downwind moving blades, reduces air resistance to the upwind moving blades and reduces turbulence as the wind stream exit the housing structure. The two side deflectors redirect the wind stream that should have spilt to the side to the downwind moving blades. Together the center enhancer and the two side deflectors increase the velocity and pressure of the wind to the downwind moving blades of the two rotors thereby extracting more energy from the wind. The center enhancer and the two side deflectors also provide for the structural integrity of the machine.

The wind turbine housing is a cylindrical structure with two levels of horizontal platform. The upper level platform houses the two turbine rotors, the center enhancer and the two side deflectors. The lower level platform houses the gears of the two turbine rotors, the transmission, the generator, the yaw drive mechanism, the brake mechanism and the controller.

The wind turbine cylindrical housing with no components protruding outside the said housing except for the wind vane on top of the roof, and with the two turbine rotors rotating inside said housing makes this ideal for installation on a constricted places such as on a sailing vessel or on top of the roof of a narrow building. The wind turbine can rotate 360° without the risk of its rotors fouling out any lines, cable or antennae and poses less risk to human working in its vicinity.

The wind turbine cylindrical structure is being orient properly into the wind by the yaw drive mechanism and the controller that communicates with the wind vane. The yaw drive is coupled by gear to the tower adaptor and rotates on a turntable bearing assembly.

The wind turbine can range in any size from several inches in diameter which can be installed on top of a lamp post and provide electrical power to a remote street lamp to several feet in diameter which can be installed on a wind farm. The present invention also poses less danger to birds than the propeller type wind machines.

On a sailing vessel the wind turbine can be modified to prove direct mechanical power to the vessel's propeller by using a system of gears and shafts.

The wind turbine can also be modified to work as a hydro turbine. A floating water sealed container can house the power generating components such as the generator and the transmission. The rotors housing structure, the rotors, the center enhancer and the side deflectors are then submerged underneath to receive the free flowing water. An anchor and a cable or other means can be used to keep the machine in place.

### BRIEF DESCRIPTION OF THE DRAWINGS

The following descriptions and referenced drawings are for selected preferred embodiments of the present invention. Naturally, changes, may be made to the disclosed embodiments while still falling within the scope and spirit of the present invention and the patent granted to its inventor.

FIG. 1 is a perspective view of an embodiment of the vertical axis wind turbine with the roof and top plate cut away to show the arrangement and relationship of the two turbine rotors, the center enhancer, the two side deflectors and the cylindrical housing structure.

FIG. 2 is a top view of the embodiment shown in FIG. 1.

FIG. 3 is a top view of the embodiment shown in FIG. 1 showing the movement of the wind stream as indicated by the arrows.

FIG. 4 is a front elevation view of the vertical axis wind turbine showing an embodiment of the invention.

FIG. 5 is a side elevation view of the vertical axis wind turbine showing an embodiment of the invention.

FIG. 6a is a perspective view of the lower level platform of the invention showing the gears of the two turbine rotors coupled by gear to the brake.

FIG. 6b is a perspective view of the same lower level platform of FIG. 6a showing the arrangement of the gearbox, the generator, the yaw drive and the controller.

FIG. 7 is a top view of the embodiment of the wind turbine shown in FIG. 6a and FIG. 6b with their combined components, and the gears shown as a circular dotted line.

FIG. 8 shows a simplified modification of the vertical axis wind turbine shown in FIG. 5 from which the yaw drive, the brake, and the controller are omitted and a tail vane of substantial size is added and is a side elevation view of an embodiment of the invention.

### DETAILED DESCRIPTION OF THE DRAWINGS

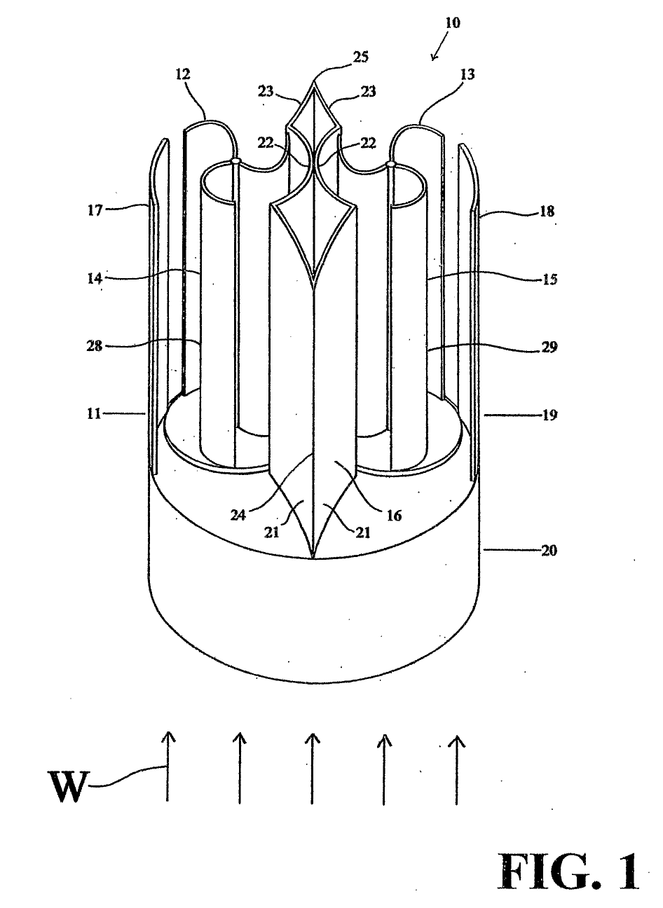

FIG. 1 shows the general arrangement of a vertical axis wind turbine 10 with two turbine rotors 12 and 13 with a plurality of curved blades 14 and 15, a center enhancer 16, the two side deflectors 17 and 18, and the wind turbine cylindrical housing structure 11 with two levels of horizontal platform, the upper level platform 19 and the lower level platform 20. It further shows sections of the center enhancer 16 that includes the leading edge 24, the front deflector 21, the upwind blade cavity 22, the turbulence reducer 23 and the trailing edge 25.

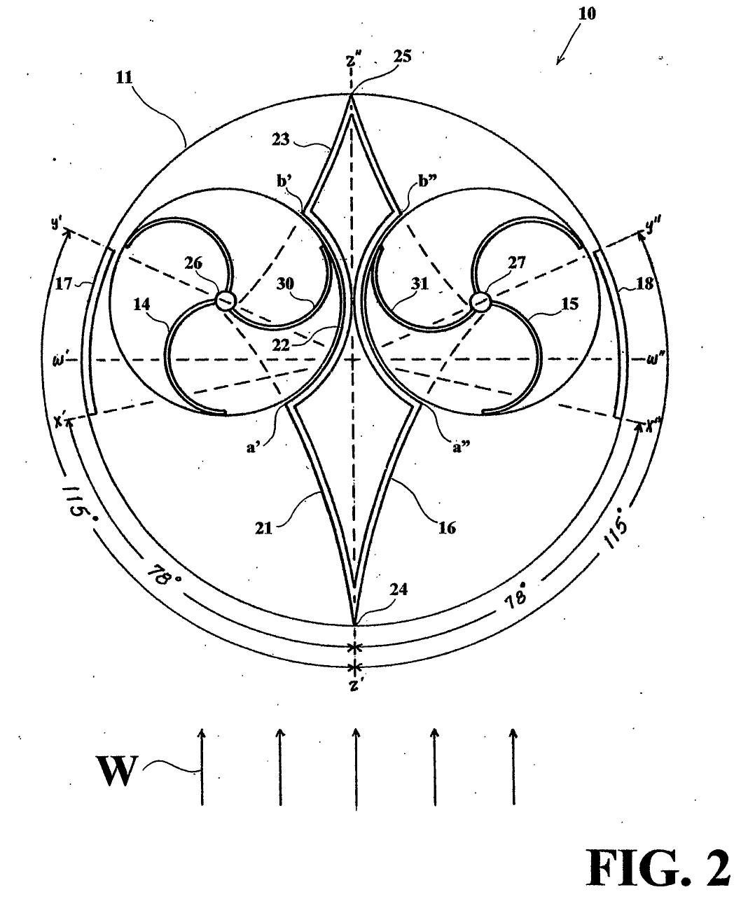

FIG. 2 is a top view of the embodiment shown in FIG. 1 and shows the two turbine rotors 12 and 13 and the positioned on opposite sides of the center enhancer 16 and somewhat behind the line of the center latitudinal axis w′-w″ of the housing structure. The two turbine rotors 12 and 13 vertical center axis lies on the line c′-y′ and on the line c′-y″ on opposite side, which is along the line of angle 115° measured from the front of the center longitudinal axis z′-z″ and along the point that provides the rotor blades 12 and 13 maximum swept area without touching the center enhancer 16 and the side deflectors 17 and 18.

The center enhancer 16 has three sections and shaped symmetrically on both sides. The front section is the front deflector 21. The front deflectors 21 is sharp at the leading edge 24 and curve concavely equally on opposite sides towards the downwind moving blades 28 and 29 of the two turbine rotors 12 and 13 covering a substantial part of the upwind moving blades 30 and 31 but not all as the curving flow of the wind stream carries the bulk of the wind stream towards the downwind moving blades 28 and 29 with only insignificant loss. It ends at point a′ and a″ on opposite sides of the center enhancer 16 short of the circular part of the two turbine rotors 12 and 13 and if continue will trace an imaginary line that is tangential to the rotor shaft side on the downwind moving blades. The sharper the contour of the front deflector 21 without compromising its purpose of eliminating the headwind to the upwind moving blades 30 and 31 the better it will decrease the drag on the front deflector 21 thereby contributing further to the efficiency of the machine.

The middle section of the center enhancer 16 is the circularly shaped upwind blade cavity 22 on both sides of the center enhancer 16 and abreast of the two turbine rotors 12 and 13. They provide spaces for the circular path of the two turbine rotors 12 and 13. As the wind stream flows to the downwind moving blades 28 and 29 a drop in air pressure occurs in the upwind blade cavity 22 which reduce air resistance to the upwind moving blades 30 and 31 as it rotates in its axis 26 and 27 thereby contributing further to the efficiency of the machine. The upwind blade cavity 22 start at point a′ and a″ on opposite sides of the center enhancer 16 and followed a circular path toward the rear ending at point b′ and b″ on opposite sides and covering about a third of the rear part of the upwind moving blades 30 and 31.

The rear section of the center enhancer 16 is the turbulence reducer 23. The turbulence reducer 23 starts from the rear end of the upwind blade cavity at point b′ and b″ on opposite sides of the center enhancer 16 and curve concavely towards the rear tapering to a sharp trailing edge 25. This reduces air turbulence as the wind stream exit the wind turbine structure creating smoother airflow contributing further to the efficiency of the machine.

The two side deflectors 17 and 18 are positioned on opposite sides of the center enhancer 16 abreast of the two turbine rotors 12 and 13 and flushed with the housing structure 11 side. The side deflectors 17 and 18 redirect the wind stream that should have spilt on the side towards the downwind moving blades 28 and 29 thereby increasing more the wind velocity and pressure on that blades. They have similar circular shape as the side of the housing structure 11, and the leading edge of the two side deflectors 17 and 18 start at point x′ and x″ on opposite sides, a point intersected at the side of the housing structure by a line of angle 78° measured from the front of the center longitudinal axis z′-z″ and the trailing edge ends at points y′ and y″ on opposite sides, a point intersected at the side of the housing structure by a line of angle 115° measured from the front of the center longitudinal axis z′-z″.

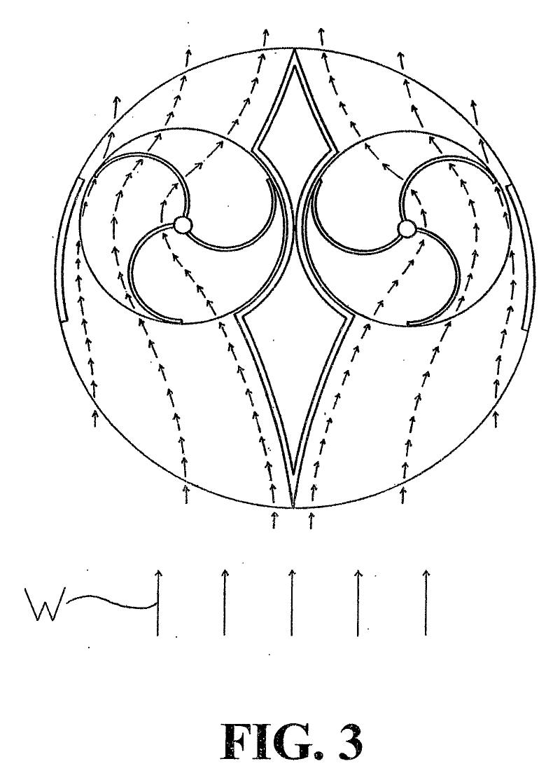

FIG. 3 is a top view of the embodiment shown in FIG. 1 showing the movement of the wind stream as indicated by the arrows. As the wind stream enters the front of the wind turbine structure the wind heading into the upwind moving blade is deflected by the front deflector into the downwind moving blade and into the side deflector. The wind stream is squeeze into a narrower area causing it to increase in pressure and velocity. As the wind stream pass the trailing edge of the side deflector the wind pressure dissipates and the wind stream spreads out again. The turbulence reducer helps the wind stream spread out evenly and minimize turbulence.

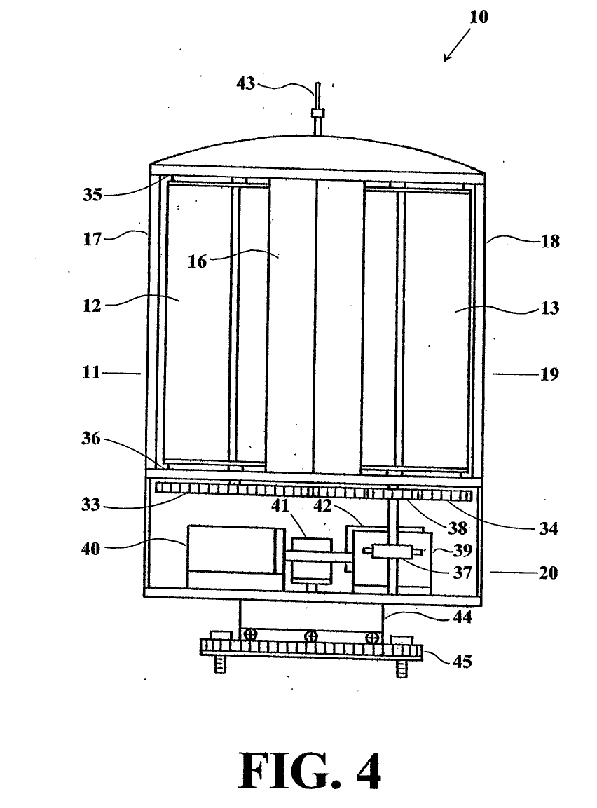

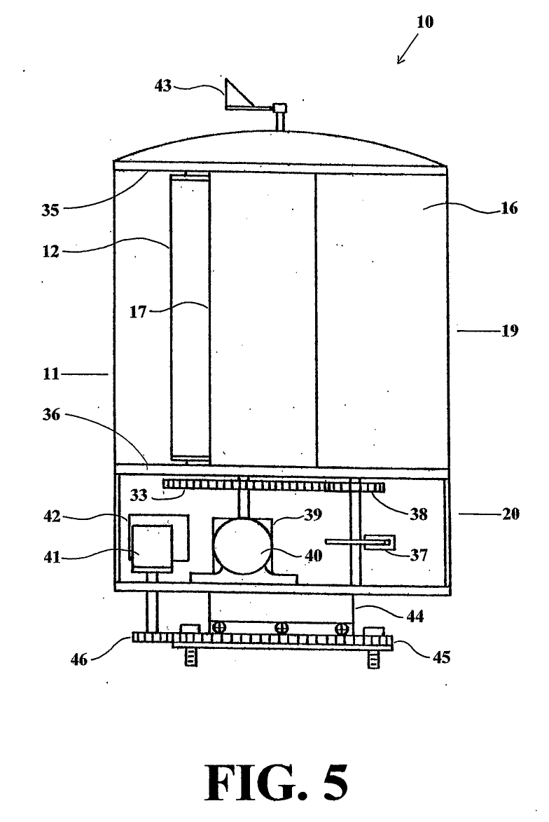

FIG. 4 is a front elevation view of the wind turbine and FIG. 5 is the side elevation view and both shows some similar components of the invention viewed at different angle. The wind turbine has two levels of horizontal platform, the upper level platform 19 and the lower level platform 20. The upper level platform 19 houses the two turbine rotors 12 and 13, the center enhancer 16 and the two side deflectors 17 and 18. The lower level platform 20 is shown here with outer covering removed for the sake of illustration houses the gears 33 and 34 of the two turbine rotors, the brake 37 coupled by gear 38 to the rotor gears 33 and 34, the gear box 39, the generator 40, the yaw drive 41 and the controller 42. The upper ends of the center enhancer 16 and the two side deflectors 17 and 18 are strongly attached to the ceiling plate 35 and similarly their bottom ends strongly attached to the floor plate 36. Together they provide structural integrity to the housing structure. At the roof of the housing structure is a wind vane 43. Strongly attached underneath the housing structure 11 is the turntable bearing assembly is the tower adaptor 45 with gear at the outer rim where the yaw drive gear 46 is coupled. The controller 42 communicates with the wind vane 43 and the yaw drive 41 and orients the machine properly into the wind. The controller 42 communicates also with the turbine rotors 12 and 13 and the brake 37 and activates the brake according as how it is programmed in the controller 42.

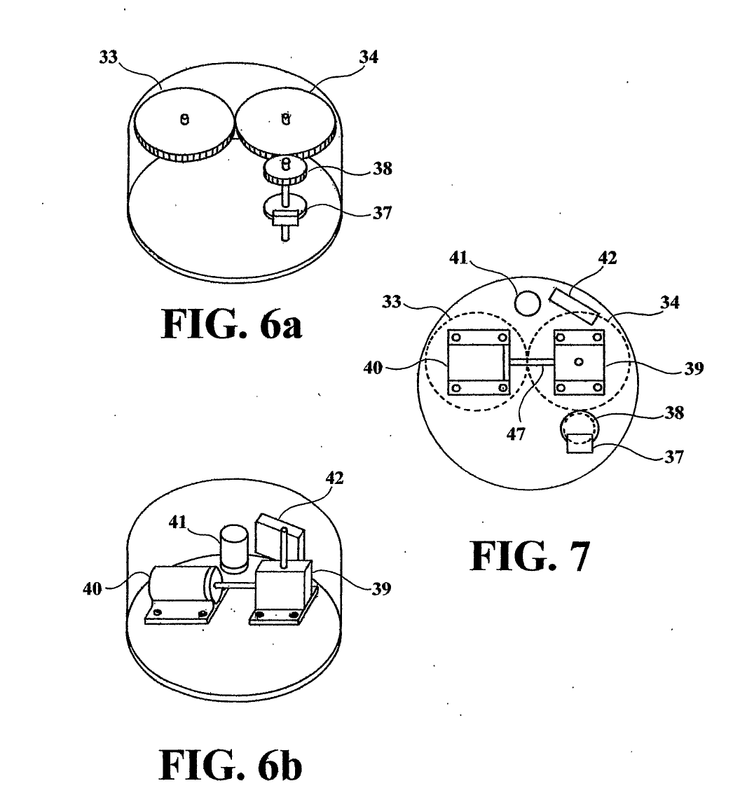

FIG. 6a and FIG. 6b is a perspective view of the same lower level platform of the wind turbine with upper floor plate and front covering removed for the sake of illustration showing various components of the machine.

FIG. 6a shows the two gears 33 and 34 of the two turbine rotors and coupled to the brake 37 by gear 38. The two turbine rotors rotate synchronously in opposite directions and the brake 37 activates only according to the command of the controller.

FIG. 6b shows the gearbox 39 coupled to the generator 40 by power shaft 47, the yaw drive 41 and the controller 42.

FIG. 7 is the top view of the embodiment shown in FIG. 6a and FIG. 6b and showing all the combined components comprising the gearbox 39 coupled by power shaft 47 to the generator 40, the controller 42, the yaw drive 41, the brake 37, and shown in dotted circular lines the turbine rotor gears 33 and 34 and the brake gear 38.

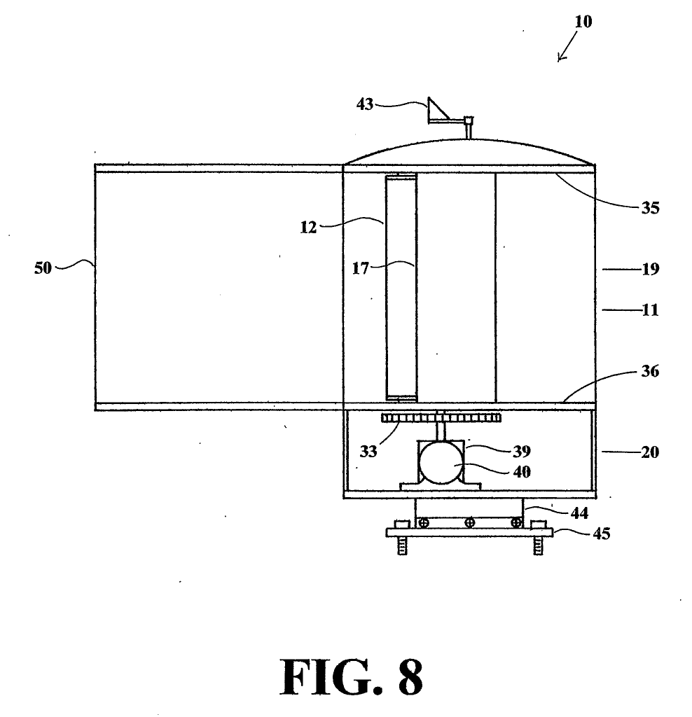

FIG. 8 shows a simplified modification of the vertical axis wind turbine shown on FIG. 5 from which the yaw drive, the brake and the controller are omitted and a tail vane 50 of substantial size is added which will orient properly the wind turbine 10 into the wind by the action of the wind alone. This wind turbine with a tail vane is ideal for use in places where there is a good space for the tail vane to swing to such as rural or farm area. Because of its high starting torque this wind turbine is also ideal for use in pumping water. And also because of its simple design and few moving parts makes this wind turbine sturdy, cost less, easy to construct and requires less maintenance. Furthermore in a place where there is a good solid ground to install the wind turbine, other components of the machine such as the gearbox and generator or water pump can be relocated at the base of the tower. Bevel gears and power shafts can then be used to transmit power to the gearbox or water pump. By this way the weight of the machine and the height of the lower platform, which now only houses the gears can be further reduced. This will further reduce air resistance, turbulence and stress to the machine structure.

1. A vertical axis wind turbine that converts wind energy into electrical or mechanical energy comprising:
two turbine rotors with plurality of curved blades, coupled together by gears and rotating synchronously in opposite directions and located symmetrically on opposite sides of a center enhancer;
said multi-function center enhancer operative to divert and direct a wind stream equally on both sides towards downwind moving blades of the two turbine rotors, thereby reducing local turbulence;
two side deflectors located on opposite sides of the center enhancer and abreast of the two turbine rotors, deflecting the wind stream that comes from the center enhancer towards the downwind moving blades of the two turbine rotors;
a yaw drive that orients the turbine in relation to the wind stream;
a brake mechanism that controls the speed of the two turbine rotors;
a controller that controls the function of the yaw drive mechanism and the brake mechanism; and
a vertically oriented cylindrical housing for turbine components mounted on a turntable bearing assembly.

2. A wind turbine as described in claim 1 wherein the two turbine rotors are positioned on opposite sides of the center enhancer whose vertical axis lies along the line of angle 115° measured from a front of a central longitudinal axis and at a point that provides the rotor blades maximum swept area without touching the center enhancer and the side deflector.

3. A wind turbine as described in claim 2 wherein the two rotor shafts are mounted to a ceiling plate and a floor plate by mounting bearings.

4. A wind turbine as described in claim 1 wherein the center enhancer is positioned at the center of an upper level platform of the housing, and having a symmetrical shape on both sides and having three sections comprising:
a) a front section as a front deflector with a sharp leading edge curving concavely on opposite sides towards the downwind moving blades of the two turbine rotors stopping short of their circular path and characterized by the feature that if continued would trace an imaginary line that is tangential to the rotor shaft side on the downwind moving blades; said front deflector covering a substantial part of the upwind moving blades from the headwind but not all;
b. a middle section as an upwind blade cavity having a symmetrical shape on both sides of the center enhancer and providing circular paths for the rotor blades, and having a leading part starting at the end part of the front deflector and the rear part ends at the rear of the upwind moving blades covering about a third part of the upwind moving blades;
c. a rear part as a turbulence reducer, measured from the rear end of the upwind blade cavity and curving concavely towards the rear end tapering to a sharp trailing edge.

5. A wind turbine as described in claim 4 wherein the leading edge and the trailing edge of the center enhancer are flush with the side of the cylindrical housing structure.

6. A wind turbine as described in claim 4 wherein a top end of the center enhancer is attached to the ceiling plate and a bottom end is attached to the floor plate.

7. A wind turbine as described in claim 1 wherein the two side deflectors are positioned on opposite sides of the center enhancer abreast of the two turbine rotors and flush with a side of the housing; the leading edge thereof lying at a side of the housing at a point intersected by a line of angle 78° as measured from the front of the center longitudinal axis and a trailing edge thereof lying at a side of the housing at a point intersected by a line of angle 115° as measured from the front of the center longitudinal axis.

8. A wind turbine as described in claim 7 wherein the two side deflectors have a circular shape matching a side of the housing.

9. A wind turbine as described in claim 7 wherein a top end of the side deflector is attached to the ceiling plate and a bottom end is attached to the floor plate.

10. A wind turbine as described in claim 1 wherein the cylindrical housing with two levels of horizontal platforms comprises:
a) a roof with a wind vane on top;
b) the upper level platform having a ceiling plate and a floor plate where the two turbine rotors, the center enhancer and the two side deflectors are installed;
c) the lower level platform where components comprising a generator, a transmission, rotor gears, a brake, a yaw drive and said controller are housed; and a side covering is provided to protect the components from the elements.

11. A wind turbine as described in claim 1 wherein one of the rotor shafts continue downward to the gear box which is in turn connected to the generator by power shaft to produce electricity.

12. A wind turbine as described in claim 1 wherein a controller is provided having two major functions, comprising:
communicating with a wind vane and the yaw drive through a sensor and orienting the windmill into the wind; and
communicating with the rotors and the brake through a sensor and activating the brake according to how it is programmed in the controller.

13. A wind turbine as described in claim 12 wherein the yaw drive is coupled by gears to a tower adaptor for holding the turbine to orient the turbine into the wind stream according to a command of the controller.

14. A wind turbine as described in claim 12 wherein the brake is coupled by gears to the turbine rotors and activates upon a command of the controller.

15. A wind turbine as described in claim 1 wherein a turntable bearing assembly is attached underneath the housing for rotation thereof.

16. A wind turbine as described in claim 15 having a tower adaptor attached underneath the turntable bearing assembly and where said tower adaptor is provided with means for ready installation to any strong structure such as a top of a tower, roof of a building or deck of a sailing vessel.

17. A wind turbine as described in claim 1 wherein a tail vane of substantial size is attached to the trailing edge of the center enhancer with its height approximately equal to the height of the center enhancer and its width approximately equal to the diameter of the housing.
